(19) United States
(12) Patent Application Publication
(10) Pub. No.: US 2025/0217701 A1
(43) Pub. Date: Jul. 3, 2025

(54) METHODS AND APPARATUSES RELATING TO ANALYTICS IN A WIRELESS COMMUNICATIONS NETWORK

(71) Applicant: LENOVO (SINGAPORE) PTE. LTD., Singapore (SG)

(72) Inventors: Dimitrios Karampatsis, Ruislip (GB); Ishan Vaishnavi, München (DE)

(73) Assignee: Lenovo (Singapore) Pte. Limited, Singapore (SG)

(21) Appl. No.: 18/850,393

(22) PCT Filed: May 10, 2022
(86) PCT No.: PCT/EP2022/062706

§ 371 Date: Sep. 24, 2024

(30) Foreign Application Priority Data
Mar. 24, 2022 (GR) 20220100260

(51) Int. Cl. G06N 20/00

(52) U.S. Cl. CPC G06N 20/00

(57) ABSTRACT

There is provided a method comprising determining that identifying an accuracy of a ML model for deriving analytics for an analytic ID is required based on feedback received from an analytics consumer, receiving, from a first network function, a first set of data, wherein the first set of data was collected in the past and used to train the ML model, receiving, from a second network function, a second set of data corresponding the analytic ID, wherein the second set of data is real time data, and determining the accuracy of the ML model by comparing the first set of data and the second set of data.

### FIELD

The subject matter disclosed herein relates generally to analytics in a wireless communications network.

### BACKGROUND

In 3GPP wireless communications networks, analytics may be provided by a Network Data Analytics Function (NWDAF). The NWDAF derives analytics using data/events collected from one or more network entities and provides the derived analytics to one or more analytics consumers.

NWDAFs may derive analytics by using a Machine Learning (ML) model on the collected data/events.

### SUMMARY

There is a need to improve the accuracy of analytics provided by NWDAFs.

Disclosed herein are procedures for improving the accuracy of analytics provided by NWDAFs.

There is provided a method comprising determining that identifying an accuracy of a ML model for deriving analytics for an analytic ID is required based on feedback received from an analytics consumer, receiving, from a first network function, a first set of data, wherein the first set of data was collected in the past and used to train the ML model, receiving, from a second network function, a second set of data corresponding the analytic ID, wherein the second set of data is real time data, and determining the accuracy of the ML model by comparing the first set of data and the second set of data.

There is provided an apparatus comprising a processor configured to determine that identifying an accuracy of a ML model for deriving analytics for an analytic ID is required based on feedback received from an analytics consumer, receive, from a first network function, a first set of data, wherein the first set of data was collected in the past and used to train the ML model, receive, from a second network function, a second set of data corresponding the analytic ID, wherein the second set of data is real time data, and determine the accuracy of the ML model by comparing the first set of data and the second set of data.

There is provided a method comprising receiving a plurality of machine learning (ML) models for deriving analytics for an analytic ID, receiving a request for analytics for the analytics ID, determine a plurality of analytics outputs for the requested analytics using the plurality of ML models associated with the requested analytics, and determining an accuracy for each of the plurality of ML models based on the plurality of analytics output.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for improving analytics accuracy will now be described, by way of example only, with reference to the accompanying drawings, in which:

FIG. 1 illustrates an example wireless communication system;

FIG. 2 illustrates a user equipment apparatus;

FIG. 3 illustrates a network node;

FIG. 4 illustrates a method for improving analytics accuracy;

FIG. 5 illustrates another method for improving analytics accuracy;

FIG. 6 illustrates a wireless communication system for improving analytics accuracy;

FIG. 7 illustrates communications between entities within the wireless communication system of FIG. 6;

FIG. 8 illustrates another wireless communication system for improving analytics accuracy; and

FIG. 9 illustrates communications between entities according to a further embodiment.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures.

Currently, when an analytics consumer requests analytics from an NWDAF, the analytics consumer may include in the request a target area and/or a target user equipment (UE) or group of UE(s). The NWDAF derives analytics by collecting data/events from one or more Network Functions (NFs), ensuring the data are from the target area requested or involve the target UE(s). The analytics are derived taking into account a static location of UEs based on an Access and Mobility Function (AMF) determining a UE entering or leaving a specific area of interest with a granularity of Tracking Area(s) or Cell ID(s).

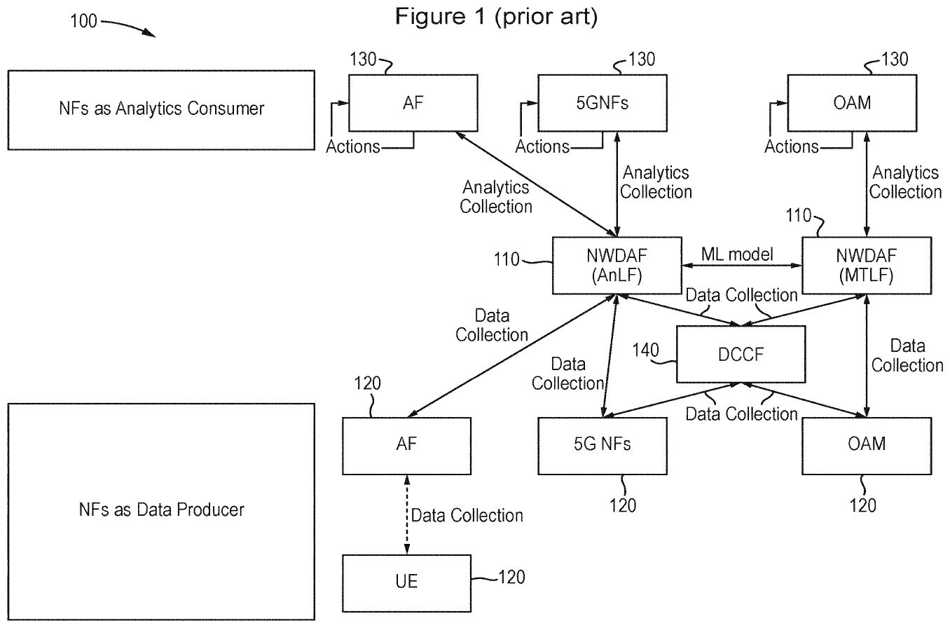

FIG. 1 illustrates an example wireless communications system 100. The system 100 comprises a plurality of NWDAFs 110, a plurality of Data Producer NFs 120, a plurality of Analytics Consumer NFs 130 and a Data Collection Co-ordination Function (DCCF). In the current Release 16 and Release 17 3GPP architecture, the NWDAFs 110 (defined in 3GPP TS 23.288 v17.2.0) provides analytic output to one or more of the Analytics Consumer NFs 130 based on data collected from one or more Data Producer NFs 120. At least part of the collected data may be collected via the DCCF 140. The analytic output is derived by the NWDAFs 110 using a trained ML model.

As part of Release 18 work, one objective is to improve the analytics accuracy of the analytics provided by the NWDAFs 110. An issue is that analytics accuracy using a trained ML Model may deteriorate in time. One cause of such scenario is the case of an ML Model Drift. ML models are trained using data collected from one or more NFs. With time the data collected becomes inaccurate or invalid (e.g. when network operator changes the resources for a NF), which results in a “drift” in the accuracy of the analytics provided by the ML model. Due to this drift, the ML model keeps becoming unstable and the predictions made by the ML model become erroneous with time.

The present application presents a solution to this problem by providing ways for an NWDAF to determine an accuracy of an ML model and decide actions accordingly.

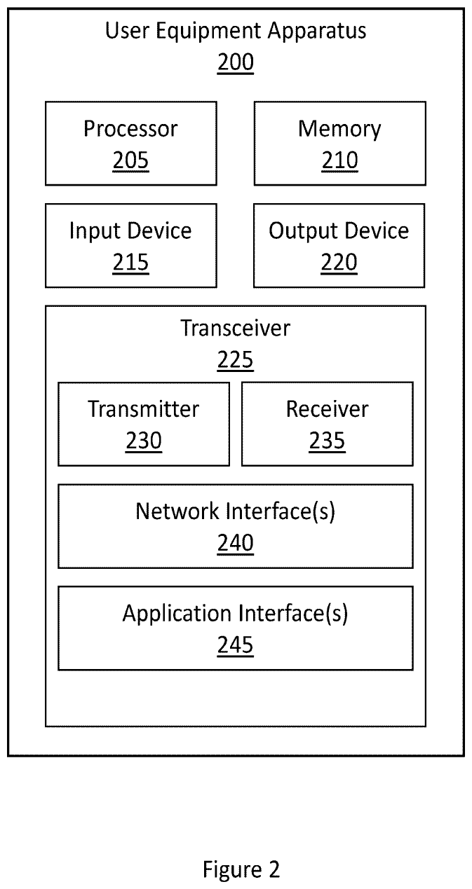

FIG. 2 depicts a user equipment apparatus 200 that may be used for implementing the methods described herein. The user equipment apparatus 200 is used to implement one or more of the solutions described above. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the above-described UE behaviors. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as describe above. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide UL communication signals to a base unit of a wireless communications network. Similarly, the one or more receivers 235 may be used to receive DL communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

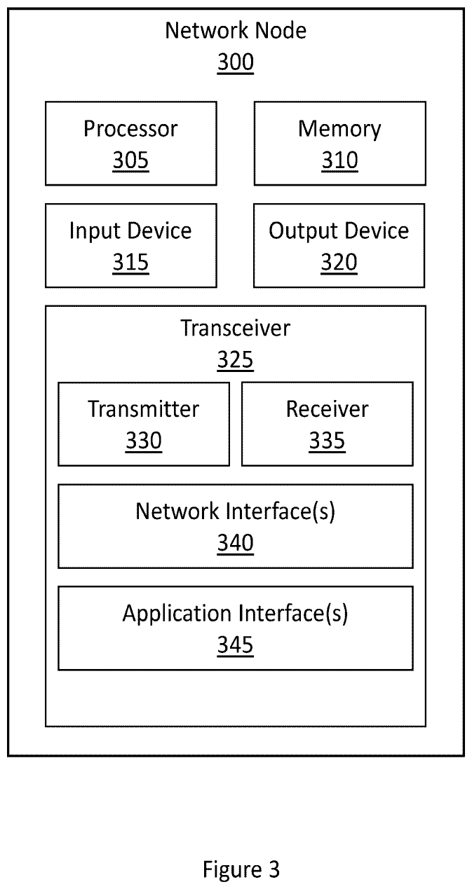

FIG. 3 depicts further details of the network node 300 that may be used for implementing the methods described herein. The network node 300 may be one implementation of an entity in the wireless communications network. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described above. The memory 310 may also stores program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

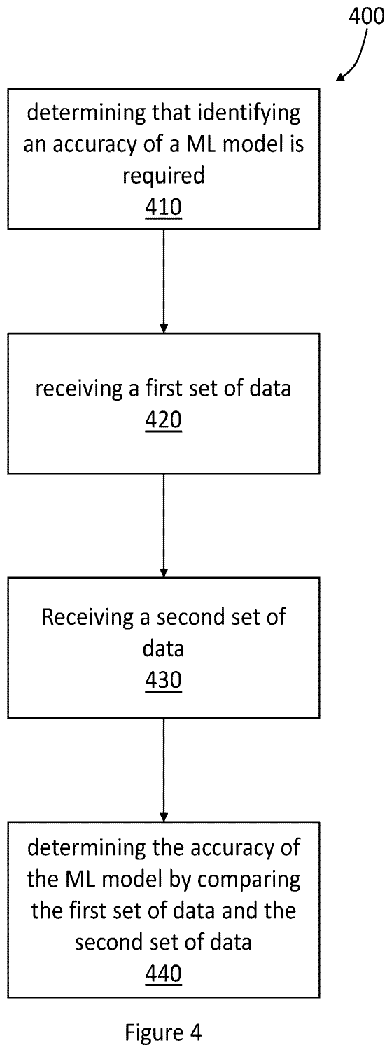

FIG. 4 illustrates a method 400 for improved analytics accuracy. The method 400 comprises determining 410 that identifying an accuracy of a ML model for deriving analytics for an analytic ID is required based on feedback received from an analytics consumer. The method 400 further comprises receiving 420, from a first network function, a first set of data, wherein the first set of data was collected in the past and used to train the ML model. The method 400 further comprises receiving 430, from a second network function, a second set of data corresponding the analytic ID, wherein the second set of data is real time data. The method 400 further comprises determining 440 the accuracy of the ML model by comparing the first set of data and the second set of data. The feedback of the analytics consumer may be an action of the consumer based on analytics derived using the ML model. The method 400 may further comprise receiving a minimum accuracy for the ML model. The determining 410 that identifying the accuracy of the ML model is required may be based on the minimum accuracy. The method 400 may further comprise re-training the ML model in response to determining that the accuracy of the ML model is below a threshold. The method 400 may further comprise notifying a network function that the accuracy of the ML model is below the threshold. The method 400 may further comprise providing the re-trained ML model to the network function. The method may further comprise subscribing to the first set of data and the second set of data. The method may be performed by an NWDAF Model Training Logical Function (MTLF). There is further provided an apparatus comprising a processor configured to perform the above-described method 400. The apparatus may be the user equipment apparatus 200 or network node 300 described above with reference to FIGS. 2 and 3.

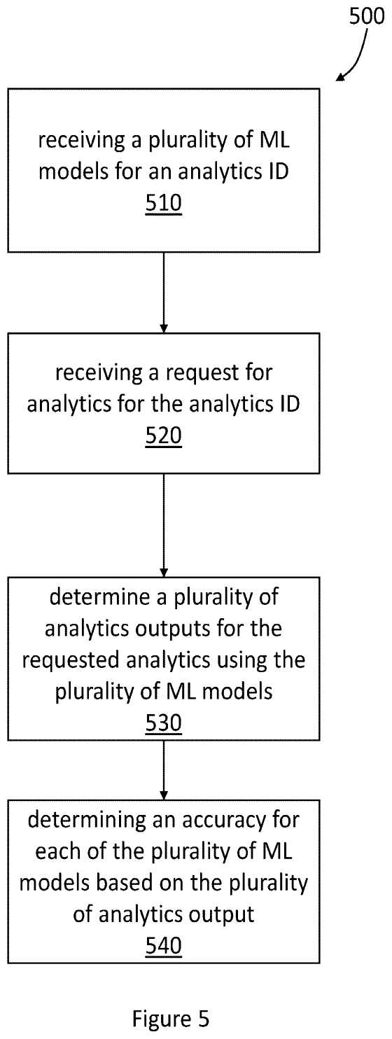

FIG. 5 illustrates another method 500 for improving analytics accuracy. The method 500 comprises receiving 510 a plurality of machine learning (ML) models for deriving analytics for an analytics ID, receiving 520 a request for analytics for the analytics ID, determining 530 a plurality of analytics outputs for the requested analytics using the plurality of ML models associated with the requested analytics, and determining 540 an accuracy for each of the plurality of ML models based on the plurality of analytics output. The method 500 may further comprise providing the accuracies for the plurality of ML models to a network function. The method 500 may further comprise providing the plurality of analytics outputs for the requested analytics to an analytics consumer. The method 500 may be performed by a NWDAF Analytics Inference Logical Function (AnLF).

There is further provided an apparatus comprising a processor configured to perform the above-described method 500. The apparatus may be the user equipment apparatus 200 or network node 300 described above with reference to FIGS. 2 and 3.

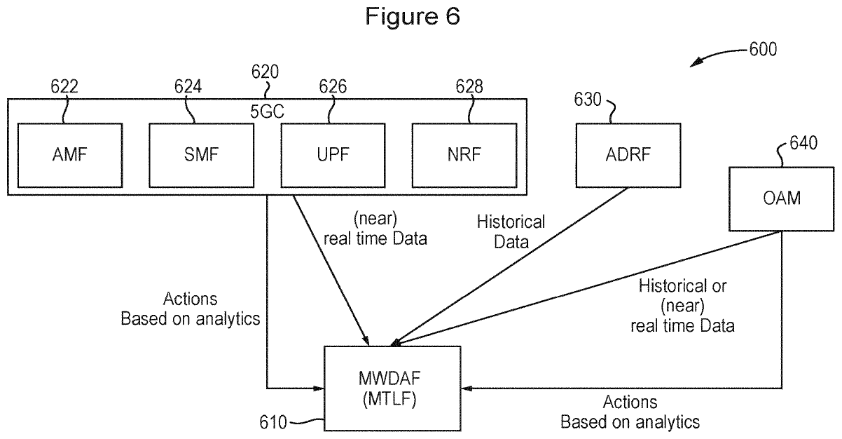

FIG. 6 illustrates a wireless communication system 600 for improving analytics accuracy according to a first embodiment. The system 600 comprises an NWDAF 610, a 5G core (5GC) 620, an Analytical Data Repository Function (ADRF) 630, and an Operations and Management function (OAM) 640. The 5GC 620 comprises an Access and Mobility Management Function (AMF) 622, a Session Management Function (SMF) 624, a User Plane Function (UPF) 626 and a Network Repository Function (NRF) 628. The general roles of these functions in the context of 3GPP networks is well understood and will not be described herein.

In the first embodiment, the NWDAF 610 that supports model training (i.e. the NWDAF MTLF) identifies ML model drift or data drift by comparing the data collected to train the ML model with real time data. The NWDAF MTLF 610 uses statistical methods (e.g. by using a specific ML model) to detect any drift between the data used to train the ML model and the real time data and determines based on the statistical analysis whether the ML model requires retraining. The NWDAF MTLF 610 may determine that the ML model requires retraining if the model drift detected exceeds a minimum accuracy threshold requested by an NWDAF Analytics Inference Logical Function (AnLF) (not shown in FIG. 6). The NWDAF MTLF 610 may determine to start identifying if a drift in an ML Model exists based on an action carried out by an analytics consumer that may significantly change the behaviour of the network. The NWDAF MTLF 610 subscribes to the analytics consumer (via the AnLF NWDAF) to receive notifications of the action taken.

Each NF that is a consumer of analytics may determine an action taking into account the analytics information received by the NWDAF AnLF. NF actions based on each analytic supported by the NWDAF AnLF are described in 3GPP TS 23.288. If the consumer is the Policy Control Function (PCF), actions taking into account analytics input are defined in 3GPP TS 23.503 clause 6.1.1.3.

If the NWDAF MTLF 610 subscribes to the PCF via the NWDAF AnLF to be notified of actions, each NF may report to the NWDAF MTLF 610 via the NWDAF AnLF the action taken. For example, if the consumer is the PCF and the PCF has subscribed to Service Experience Analytics (defined in 23.288), the PCF notifies the NWDAF MTLF 610 that the QoS for one or more UEs has been upgraded.

Alternatively, the analytics consumer may include an indication that the action taken may significantly change the behaviour of an NF, a slice or the 5GC 620 in general.

For example, changing the behaviour of an NF can occur when the analytics consumer is the SMF and the SMF selects a less loaded UPF for a Protocol Data Unit (PDU) session. In this example, the SMF may notify the NWDAF MTLF 610 via the AnLF NWDAF that traffic of UEs will be routed to a second UPF effectively increasing the load of the second UPF. The SMF can include in the feedback notification the second UPF selected. The NWDAF MTLF 610 can then determine if data drift may occur (if the NWDAF MTLF 610 trained data using NF load information from the second UPF).

For example, changing the behaviour of a slice may occur when the AMF 622 or a Network Slicing Selection Function (NSSF) is a consumer of slice load analytics from an NWDAF. If the NSSF decides to instantiate a new slice instance for a slice and route UEs to the new slice instance, the existing network slice will be less loaded resulting in a data drift as the NWDAF MTLF 610 trained the ML Model using historical data from the existing slice instance. In this scenario, the analytics consumer can indicate to the NWDAF MTLF 610 that data drift may occur due to instantiation of a new slice instance.

For example, changing the behaviour of 5GC network 620 may occur when an NF decides an action that affects the operation of the whole 5GC 620. For example, a PCF allocating a higher QoS for a number of UEs will result in increased load in the RAN and 5GC 620. If the NWDAF MTLF 610 used data from the RAN or the UPF to train a ML model then the NWDAF MTLF 610 may need to re-train the ML model with updated data. In such scenario, the analytics consumer may indicate the affected NFs (or NF types) where their behaviour will change due to the NF action.

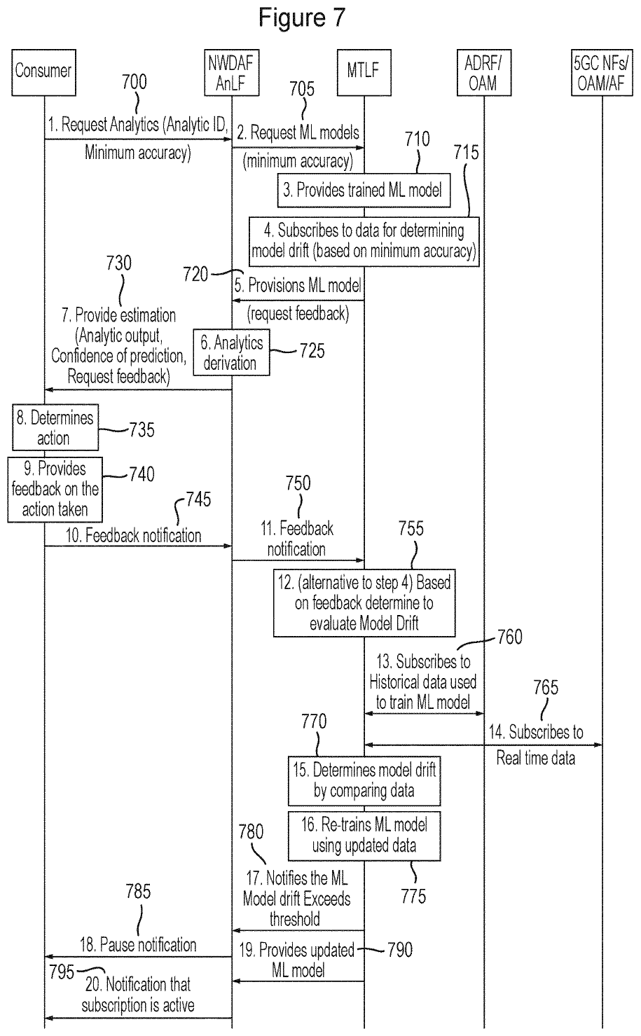

FIG. 7 illustrates communications between entities within the wireless communication system of FIG. 6. At step 700, an analytics consumer sends a request for analytics corresponding to an analytic ID to an AnLF NWDAF (e.g. as defined in 3GPP TS 23.288). The analytic ID is included in the request. For example, an analytics consumer can request analytics for an analytic ID for NF load. The request may include a minimum accuracy. The minimum accuracy may denote a confidence level required for the analytics requested (as defined in 3GPP TS 23.288).

At step 705, if the AnLF NWDAF has no ML model for the requested analytic ID, the AnLF NWDAF sends a request for a ML model from an MTLF NWDAF to derive analytics for the analytic ID requested. The request may include the minimum accuracy. The request may be a one-time request or a subscription. If the request is is a subscription, the request may include a minimum accuracy threshold to allow the MTLF NWDAF to determine when to provide an updated ML Model to the AnLF NWDAF.

The AnLF NWDAF may translate the minimum accuracy received in step 700 into a minimum ML model drift accuracy.

At step 710, the MTLF NWDAF provides the current ML model for the analytic ID.

At step 715, based on the minimum accuracy in the request, the MTLF NWDAF determines that ML model drift needs to be calculated for the provided ML model. The MTLF NWDAF may translate the minimum accuracy received in 705 into a minimum ML model drift accuracy. Alternatively, the MTLF NWDAF may be configured (e.g. by OAM) on a generic minimum accuracy drift for an ML model. The MTLF NWDAF may subscribe to data to determine the model drift.

The MTLF NWDAF may already have a trained ML model available. The MTLF NWDAF does not need to wait for a trigger from the AnLF NWDAF to start training a ML model.

At step 720, the MTLF NWDAF provides the requested ML model to the AnLF NWDAF. The MTLF NWDAF may also send a request for feedback when an analytics consumer determines an action based on analytics provided by the AnLF NWDAF. The feedback may be used to determine whether drift detection should be carried out for an ML model (see step 755)

At step 725, the AnLF NWDAF derives analytics using the provided ML model.

At step 730, the AnLF NWDAF provides the requested analytics to the analytics consumer. The AnLF NWDAF also sends a request for the consumer to provide feedback when the consumer determines an action.

At step 735, the consumer may determine an action based on the received analytics. For example, if the analytics indicate a high load at a UPF function the consumer, e.g. the SMF may select a less loaded UPF.

At step 740, based on the request for feedback the consumer determines to report the action as feedback.

At step 750, the consumer reports the action taken to the AnLF NWDAF in a feedback notification. For example, the consumer may report the UPF selected and the load of the selected UPF. Alternatively, if the consumer is a PCF, the consumer may report an upgrade or downgrade of a QoS for an application.

At step 755, the AnLF NWDAF forwards the report of the action to the MTLF NWDAF in a feedback notification.

At step 755, the MTLF NWDAF determines based on the feedback notification if the action taken by the consumer could trigger a drift in data that would invalidate the current ML model. If the action taken by the consumer could trigger a drift in data that would invalidate the current ML model, the MTFL NWDAF determines to evaluate the accuracy of the current ML model.

At step 760, the MTLF NWDAF subscribes to historical data that were used to train the current ML model (or the earliest historical data available if the data that were used to train the ML Model are not available) for the specific analytic ID from the ADRF and/or OAM (if the MTLF does have the historical data stored locally). For example, if the ML model is used for analytics of NF load the training data may be NF load data. The various different types of training data which may be used is defined in 3GPP TS 23.288.

At step 765, the MTLF NWDAF subscribes to real-time data (or near real time data) from the 5GC NFs, AF, OAM that are required to derive analytics for the analytic ID (as described for each analytic ID in 3GPP TS 23.288). For example, the real time data may be NF load data.

At steps 760 and 765, the MTLF NWDAF can determine where data drift may occur based on the feedback received from the analytics consumer/AnLF. For example, when the analytics consumer provides feedback, the feedback can include information on the NFs that are impacted from the action (e.g. selecting a less loaded UPF for traffic that would increase the load in the selected UPF). Based on the feedback, the MTLF NWDAF can determine which data need to be inspected for a data drift and whether such data drift would affect the ML Model performance.

At step 770, the MTLF NWDAF determines model drift by comparing the historical data with the real time data. The MTLF NWDAF may use statistical analysis or use AI/ML procedures to determine data/model drift.

At step 775, if the MTLF NWDAF determines that Model drift exceed a threshold, the MTLF NWDAF retrains the ML model. Based on step 770 the MTLF NWDAF can be aware of which data contribute to the drift and retrain the ML model excluding the invalid historical data.

At step 780, the MTLF NWDAF may notify the AnLF NWDAF that the ML model drift exceeds a threshold. The notification may notify the AnLF to stop using the ML model to provide analytics. The MTLF NWDAF may also provide an indication on when the updated ML model will be available.

At step 785, based on the indication received from the MTLF NWDAF the AnLF NWDAF may indicate to the analytics consumer a pause in the subscription because an ML model requires retraining. The AnLF NWDAF may also indicate the time that new analytics will be available.

At step 790, the MTLF NWDAF provides the re-trained ML model to the AnLF NWDAF.

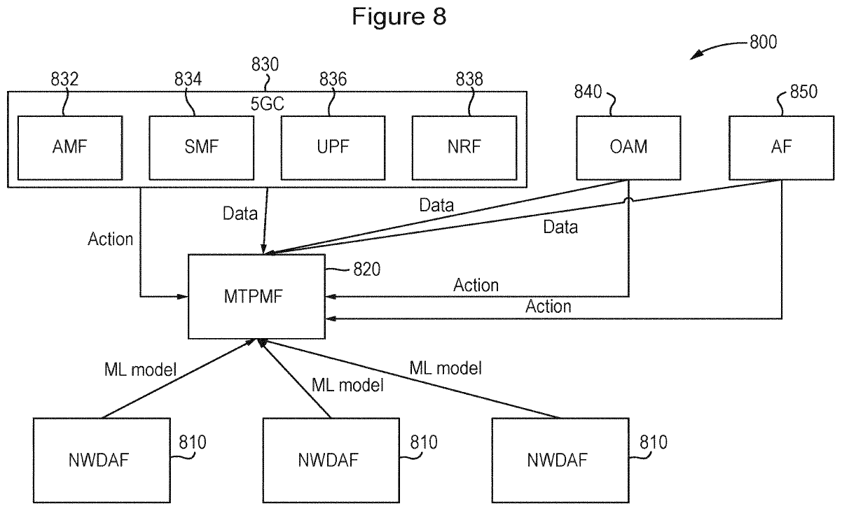

At step 795, the AnLF notifies the consumer to resume subscription, indicating analytics are available. FIG. 8 illustrates another wireless communication system 800 for improving analytics accuracy. The system 800 comprises plurality of NWDAFs 810, a Model Training Performance Monitoring Function (MTPMF) 820, a 5GC 830, an OAM 840, and an Application Function AF 850. The 5GC 820 comprises an Access and Mobility Management Function (AMF) 832, a Session Management Function (SMF) 834, a User Plane Function (UPF) 836 and a Network Repository Function (NRF) 838. The general roles of these functions in the context of 3GPP networks is well understood and will not be described herein.

In this embodiment, the consumer may be a new function, the Model Training Performance Monitoring Function (MTPMF) 820 that receives ML models from one or more NWDAF MTLFs 810 and determines data drift or model drift by comparing historical data with near real time data. The MTPMF 820 may reside in the NWDAF 810 or may be a function of OAM 840. The NWDAF 810 would provide the trained ML model to the MTPMF 820 and notify the NWDAF 810 when a drift is detected and potential data affected. The MTPMF 820 would subscribe to each 5GC NF 830, OAM 840 or AF 850 that is a consumer of analytics to provide feedback (e.g. an action of the NF) to determine if a drift detection should start (similar to the procedure illustrated by FIG. 7).

In an alternative embodiment, the consumer may be a new function, an Analytics Performance Monitoring Function (APMF) (not shown) that receives analytics from one or more NWDAF and determines the accuracy of analytics by collecting real time data information. The APMF may reside in the NWDAF or may be a function of OAM.

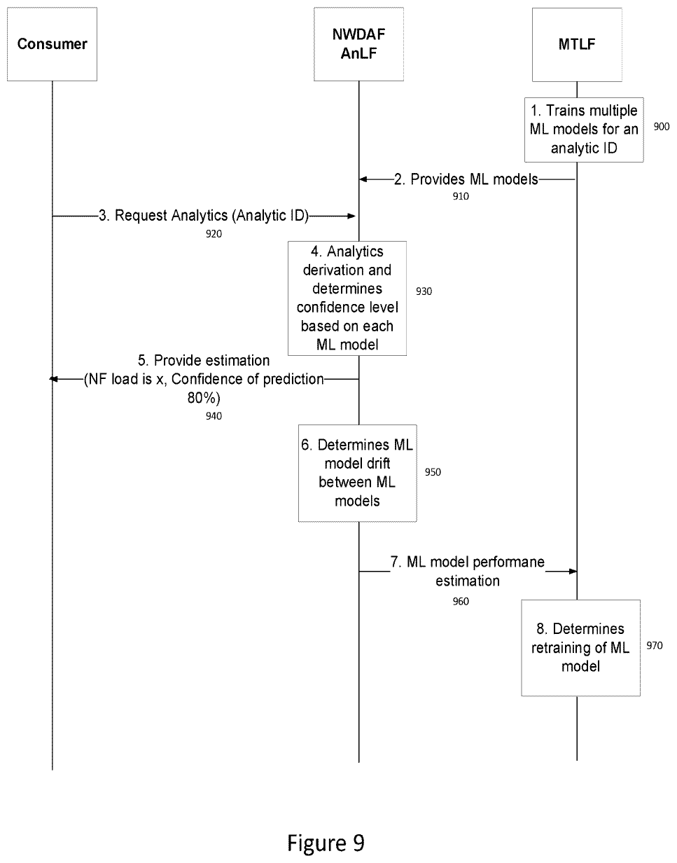

FIG. 9 illustrates communications between entities according to a further embodiment.

In the embodiment of FIG. 9, the estimation of the accuracy of an ML model is determined by receiving multiple ML models from an MTLF NWDAF and determining the performance of ML model by comparing the analytic output. If there is a difference in the analytic output between the multiple ML models the AnLF NWDAF can indicate to the MTLF the ML models that require retraining.

At step 900, the MTLF NWDAF may train multiple ML models for the same analytic ID.

At step 910, the MTLF NWDAF provides the multiple ML models to the AnLF NWDAF. The MTLF NWDAF may optionally subscribe for ML model performance feedback.

At step 920, the AnLF NWDAF receives, from an analytics consumer, a request for analytics corresponding to the analytics ID.

At step 930, the AnLF NWDAF determines a plurality of analytic outputs based on the plurality of ML models for the analytic requested. Specifically, the AnLF NWDAF determines a respective analytic output from each of the plurality of ML models for the analytics ID. The AnLF NWDAF may determine a confidence level for each of the plurality of analytics outputs corresponding to their respective ML model.

At step 940, the AnLF NWDAF provides the plurality of analytic outputs to the analytics consumer. The AnLF NWDAF may also provide the determined confidence levels to the analytics consumer.

At step 950, the AnLF NWDAF compares the performance of each ML model supporting the same Analytic ID and identifies the performance of each ML model (e.g. confidence level of analytic output, variance between each analytic output, variance of each analytic output).

At step 960, the AnLF NWDAF provides the performance estimation of each ML model to the MTLF NWDAF. Optionally, this may only be provided if the MTLF NWDAF has subscribed to receive such feedback.

At step 970, the MTLF NWDAF determines to retrain one or more of the ML models based on the performance feedback provided by the AnLF NWDAF. For example, the MTLF NWDAF may decide to retrain only the ML model with the lowest accuracy. Alternatively, the MTLF NWDAF may decide to retrain all of the ML models. The MTLF NWDAF then retrains the one or more ML models that it has decided/determined to retrain.

Thus, methods and apparatuses for providing improved analytics accuracy are provided. The main solution proposes the NWDAF to determine ML model drift by comparing a drift in data between the data used to train the ML model and near real time data. The trigger to start detecting a model drift can be based on an action made by an analytics consumer that considerably changes the network behaviour.

In the above embodiments, the NWDAF MTLF and NWDAF AnLF are separate entities (e.g. in FIG. 1). However, alternatively the MTLF and AnLF functions may be supported by a single NWDAF entity which performs the functions of both the MTLF and AnLF described above.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method performed by an apparatus, the method comprising:
determining to identify an accuracy of a machine learning (ML) model for deriving analytics for an analytic identifier based at least in part on feedback received from an analytics consumer;
receiving, from a first network function, a first set of data, wherein the first set of data was used to train the ML model;
receiving, from a second network function, a second set of data corresponding to the analytic identifier, wherein the second set of data comprises real time data; and
determining the accuracy of the ML model by comparing the first set of data and the second set of data.

2. The method of claim 1, further comprising determining that a drift from the first set of data has occurred based on the feedback received from the analytics consumer, wherein the determination to identify the accuracy of the ML model is based at least in part on the determination that the drift from the first set of data has occurred.

3. The method of claim 1, wherein the feedback of the analytics consumer indicates an action taken by the analytics consumer based at least in part on analytics derived using the ML model.

4. (canceled)

5. The method of claim 1, further comprising receiving a minimum accuracy for the ML model.

6. The method of claim 5, wherein determining to identify the accuracy of the ML model is based at least in part on the minimum accuracy.

7. The method of claim 1, further comprising re-training the ML model in response to determining that the accuracy of the ML model is below a threshold.

8. The method of claim 7, further comprising notifying a network function that the accuracy of the ML model is below the threshold.

9. The method of claim 8, further comprising providing the re-trained ML model to the network function.

10. The method of claim 1, further comprising subscribing to the first set of data and the second set of data.

11. (canceled)

12. An apparatus for wireless communication, comprising:
at least one memory; and
at least one processor coupled with the at least one memory and configured to cause the apparatus to:
determine to identify an accuracy of a machine learning (ML) model for deriving analytics for an analytic identifier based at least in part on feedback received from an analytics consumer;
receive, from a first network function, a first set of data, wherein the first set of data was used to train the ML model;
receive, from a second network function, a second set of data corresponding to the analytics identifier, wherein the second set of data comprises real time data; and
determine the accuracy of the ML model by comparing the first set of data and the second set of data.

13. The apparatus of claim 12, wherein the at least one processor is further configured to cause the apparatus to determine that a drift from the first set of data has occurred based on the feedback received from the analytics consumer, wherein the determination to identify the accuracy of the ML model is based at least in part on the determination that the drift from the first set of data has occurred.

14. The apparatus of claim 12, wherein the feedback of the analytics consumer indicates an action taken by the analytics consumer based at least in part on analytics derived using the ML model.

15. (canceled)

16. The apparatus of claim 12, wherein the at least one processor is configured to cause the apparatus to receive a minimum accuracy for the ML model.

17. The apparatus of claim 16, wherein the at least one processor is configured to cause the apparatus to determine to identify the accuracy of the ML model based at least in part on the minimum accuracy.

18. The apparatus of claim 12, wherein the at least one processor is configured to cause the apparatus to re-train the ML model in response to determining that the accuracy of the ML model is below a threshold.

19. The apparatus of claim 18, wherein the at least one processor is configured to cause the apparatus to notify a network function that the accuracy of the ML model is below the threshold.

20. The apparatus of claim 19, wherein the at least one processor is configured to cause the apparatus to provide the re-trained ML model to the network function.

21. The apparatus of claim 12, wherein the at least one processor is configured to cause the apparatus to subscribe to the first set of data and the second set of data.

22. (canceled)

23. (canceled)

24. A user equipment (UE) for wireless communication, comprising:
at least one memory; and
at least one processor coupled with the at least one memory and configured to cause the UE to:
determine to identify an accuracy of a machine learning (ML) model for deriving analytics for an analytic identifier based at least in part on feedback received from an analytics consumer;
receive, from a first network function, a first set of data, wherein the first set of data was used to train the ML model;
receive, from a second network function, a second set of data corresponding to the analytics identifier, wherein the second set of data comprises real time data; and
determine the accuracy of the ML model by comparing the first set of data and the second set of data.

25. A processor for wireless communication, comprising:
at least one controller coupled with at least one memory and configured to cause the processor to:
determine to identify an accuracy of a machine learning (ML) model for deriving analytics for an analytic identifier based at least in part on feedback received from an analytics consumer;
receive, from a first network function, a first set of data, wherein the first set of data was used to train the ML model;
receive, from a second network function, a second set of data corresponding to the analytics identifier, wherein the second set of data comprises real time data; and
determine the accuracy of the ML model by comparing the first set of data and the second set of data.
